(19) United States
(12) Patent Application Publication
(10) Pub. No.: US 2018/0177115 A1
(43) Pub. Date: Jun. 28, 2018

(54) Multipurpose Planting Hand Tool

(71) Applicant: Chao Fu Huang, Shuishang Township (TW)

(72) Inventor: Chao Fu Huang, Shuishang Township (TW)

(21) Appl. No.: 15/387,738

(22) Filed: Dec. 22, 2016

(51) Int. Cl. A01B 1/16

(52) U.S. Cl. CPC A01B 1/16

(57) ABSTRACT

A multipurpose planting hand tool includes a handle provided for a user to hold, and a hook member fixed into the handle by a root portion of a rod body and extended from the front of the handle to a distance and bent into an arc to form a hook-shaped hand tool portion. A flat deformation occurs at a position where the hook member is bent into the hand tool portion, and sawteeth are formed at an inner curved edge. Both sides of an outer curved edge are extended upwardly and focused into a small arc to form a blade-like portion, and its front is tapered to form a sharp tip. The sawteeth, the blade-like portion and the sharp tip are provided to facilitate the work of collecting and removing weeds and fallen leaves after the operations of loosening soil, weeding, sweeping leaves and removing weeds.

### BACKGROUND OF THE INVENTION

### Field of the Invention

The present invention relates to a planting hand tool, and more particularly to a multipurpose planting hand tool having a hook member coupled to the front end of a handle and a long rod selectively coupled to the rear end of the handle to facilitate collecting and removing weeds and leaves after loosening soil, weeding, sweeping and collecting fallen leaves, and removing weeds.

### Description of the Related Art

Gardening is one of the good medicines to relieve physical and mental pressures for busy people nowadays. Getting close with colorful flowers and plants can make us relax, relieve stress, stay away from pains, reduce fatigue and improve work efficiency. Therefore, there are many people setting up a gardening environment in a limited area of their home in order to have more chances to contact with flowers and plants and seek for physical and spiritual joys. Further, many other people unable to set up the gardening environment in their home look for an opportunity for a holiday farmer in order to have fun and get experience of being close with the economic crops (such as agricultural products, vegetables, flowers, etc), and most importantly, seeking for the purpose and value of being a human by getting close to the nature, soil, air, and crops, and through appropriate and moderate manual labor.

In addition to the supply of high-quality air, sunlight, and water, we also need to often do the work of loosening the soil, weeding, and fertilizing the plants for horticulture and planting, wherein the soil must be loosened before performing the work of weeding and fertilization. Therefore, regular operations including loosening the soil and weeding are important horticultural and planting work. The inventor of the present invention based on the love and years of experience on taking care of the gardening environment found out that collecting the weeds and fallen leaves of the plants while loosening soil and weeding can make the gardening work more conveniently and easily.

At present, the work of loosening soil and weeding for a small gardening or planting environment generally requires an appropriate tool such as a hook-shaped sickle or a shovel. However, the sickle or shovel is not applicable for loosening soil and weeding while collecting the weeds and fallen leaves at the same time. Therefore, some people have to buy a sector shaped sweeper in order to collect the weeds and fallen leaves conveniently. However, people have to prepare more tools to take care of the gardening environment, and thus spending more money and wasting the storage space.

### SUMMARY OF THE INVENTION

In view of the aforementioned drawbacks of the prior art, the inventor of the present invention conducted researches and experiments, and finally developed a multipurpose planting tool in accordance with the present invention to overcome the drawbacks of the prior art.

Therefore, it is a primary objective of the present invention to provide a multipurpose planting hand tool for collecting and removing weeds and fallen leaves after the operations of loosening the soil, weeding, sweeping leaves and removing weeds.

Another objective of the present invention is to provide a multipurpose planting hand tool with an adjustable handle to facilitate a user to stand or squat while using the tool.

To achieve the aforementioned and other objectives, the present invention discloses a multipurpose planting hand tool comprising: a handle, provided for a user to hold; and a hook member, having a rod body, and fixed into the interior of the handle by a root portion of the rod body, and the rod body being extended from the front of the handle to a distance and then bent into an arc to form a hook-shaped hand tool portion, and the hook member having a flat deformation at the position where the bending starts to form the hand tool portion, and a plurality of sawteeth formed at an inner edge, and both sides of the outer arc are bent upwardly and focused into a small arc to form a blade-like portion, and the front being tapered into a sharp tip.

The multipurpose planting hand tool further comprises a long handle, and the top end of the long handle being coupled to the bottom of the handle.

In the multipurpose planting hand tool, the bottom of the handle has an inner thread slot inwardly formed thereon, and the top of the long handle has an outer screw formed and extended upwardly, and the outer screw is configured to be corresponsive to the inner thread slot for a secured screw connection.

In the multipurpose planting hand tool, the bottom of the handle has an outer screw downwardly formed thereon, and the top of the long handle has an inner thread slot formed inwardly thereon, and the inner thread slot is configured to be corresponsive to the outer screw for a secured screw connection.

In the multipurpose planting hand tool, the outer edge of the handle is in a conical shape with an increasing width in a downward direction.

In the multipurpose planting hand tool, the rod body of the long handle is a flexible rod body.

In the multipurpose planting hand tool, the hand tool portion of the rod body is capable of deflecting to one side with an angle so as to facilitate the hand tool portion being more closed to the ground in using.

### BRIEF DESCRIPTION OF THE DRAWINGS

FIG. 1 is a perspective view of a first preferred embodiment of the present invention;

FIG. 2 is a side view of the first preferred embodiment of the present invention;

FIG. 3 is a cross-sectional view of Section a-a as depicted in FIG. 2;

FIG. 4 is a schematic view of loosening soil and weeding in accordance with the first preferred embodiment of the present invention;

FIG. 5 is a schematic view of pushing a grass root in accordance with the first preferred embodiment of the present invention;

FIG. 6 is a perspective view of a second preferred embodiment of the present invention;

FIG. 7 is an exploded view of the second preferred embodiment of the present invention;

FIG. 8 is a partial cross-sectional of the second preferred embodiment of the present invention;

FIG. 9 is an exploded view of a third preferred embodiment of the present invention;

FIG. 10 a partial cross-sectional view of the third preferred embodiment of the present invention;

FIG. 11 is a schematic view of loosening soil and weeding in accordance with the second and third preferred embodiments of the present invention; and

FIG. 12 is a schematic view of pushing a grass root in accordance with the second and third preferred embodiment of the present invention.

FIG. 13 is a rear view of deflecting with an angle of hand tool portion of the present invention.

FIG. 14 is a schematic view of using of the hand tool portion being more closed to the ground of the present invention.

### DETAILED DESCRIPTION OF THE PREFERRED EMBODIMENTS

The technical characteristics, contents, advantages and effects of the present invention will be apparent with the detailed description of a preferred embodiment accompanied with related drawings as follows.

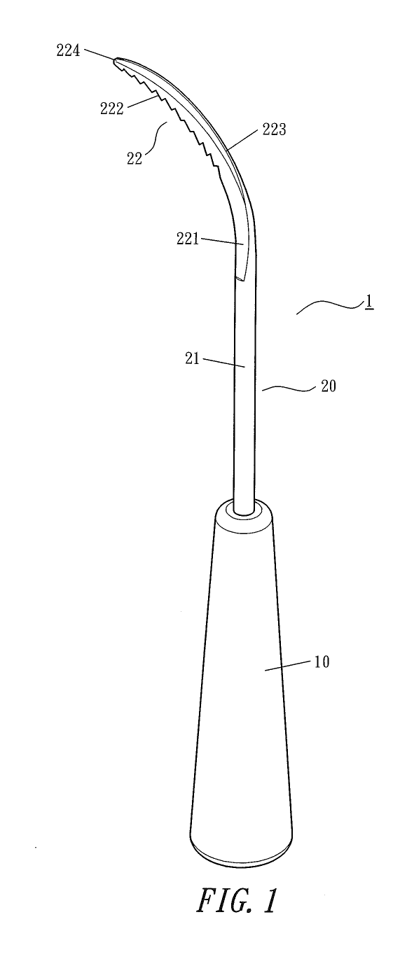

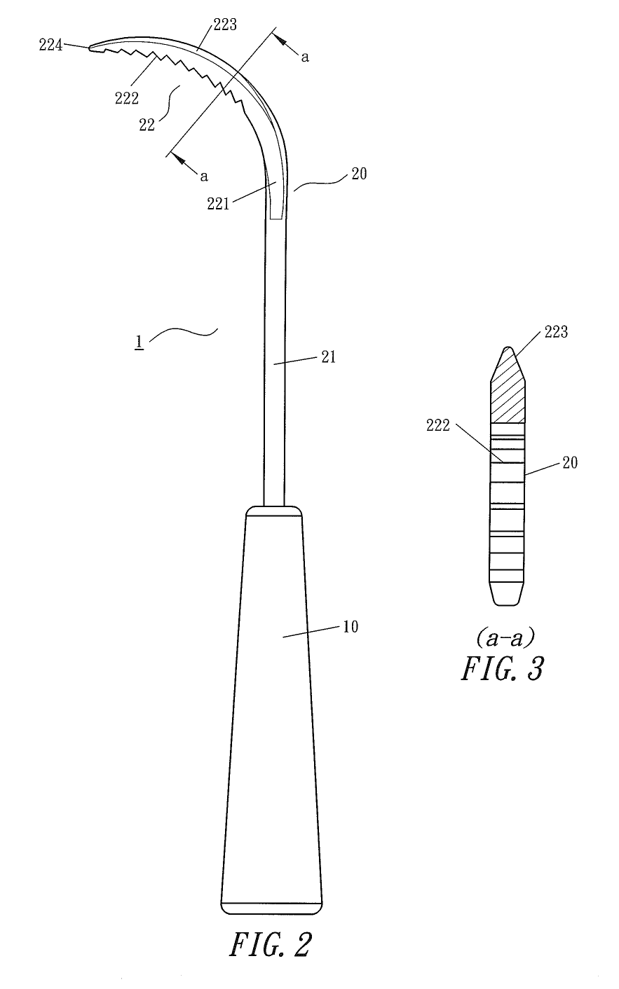

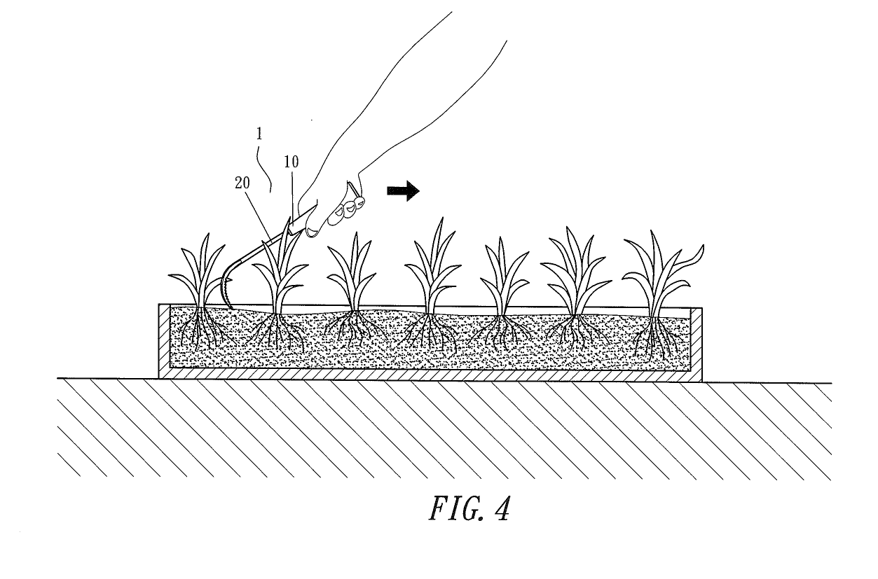

With reference to FIGS. 1 and 2 for a hand tool 1 in accordance with the first preferred embodiment of the present invention, the hand tool 1 is a hand tool particularly suitable for planting, and the hand tool 1 comprises a handle 10 and a hook member 20, wherein the handle 10 is provided for a user to hold by a palm, and the handle 10 with an outer edge in a conical shape having a width increasing in a downward direction to facilitate the user to hold the hand tool 1 (but the invention is not limited by this arrangement only. With reference to FIG. 3, the hook member 20 is fixed into the interior of the handle 10 by a root portion of a rod body 21, and then extended forwardly from the front of the handle 10 to a distance and bent into an arc to form a hook-shaped hand tool portion 22. The hook member 20 has a flat deformation 221 at a position where the hook member 20 is bent into the hand tool portion 22 and a plurality of sawteeth 222 formed at an inner arc edge of the hook member 20, and both sides of an outer arc are extended upwardly and focused into a small arc to form a blade-like portion 223, and the front end is gradually tapered into a sharp tip 224.

When the hand tool 1 is used, the user preferably squats at a low position and holds the handle 10 by a palm, so that the hand tool portion 22 of the hook member 20 is extended towards the front of the user's body, and the hook member 20 may be used for the collection and removal operation after the operations of loosening the soil, weeding, sweeping leaves and removing weeds. In the hand tool portion 22 of the hook member 20 of the hand tool 1, the plurality of sawteeth 222, the blade-like portion 223 and the sharp tip 224 are provided for the collecting and removing operations after the operation or alternating operations of loosening the soil, weeding, sweeping fallen leaves, and removing weeds. During a practical application of the hand tool 1, the sequence of using the plurality of sawteeth 222, the blade-like portion 223 and the sharp tip 224 is not limited. The trial run of using the hand tool in a planting site of the inventor of the present invention shows excellent effects before the patent application of the present invention is filed.

In general, the work in a planting site includes the collecting and removing operations after the operations of “just loosening soil”, “loosening soil and weeding”, “just weeding” and “sweeping fallen leaves and removing weeds”, wherein the operations of “just loosening soil”, “loosening soil and weeding” are front-end operations as required by the conditions of the planting site, and the collecting operations of “sweeping fallen leaves and removing weeds” is a rear-end operation. When “just loosening soil” or loosening soil and weeding takes place, the user may hold the handle 10 to insert the sharp tip 224 of the hand tool portion 22 into the soil slantingly as shown in FIG. 4, and then pull the hand tool backward to loosen the soil. If the sharp tip 224 is inserted into the soil further, then the portion of the sawteeth 222 will help scraping the soil to make the work of loosening soil more easily.

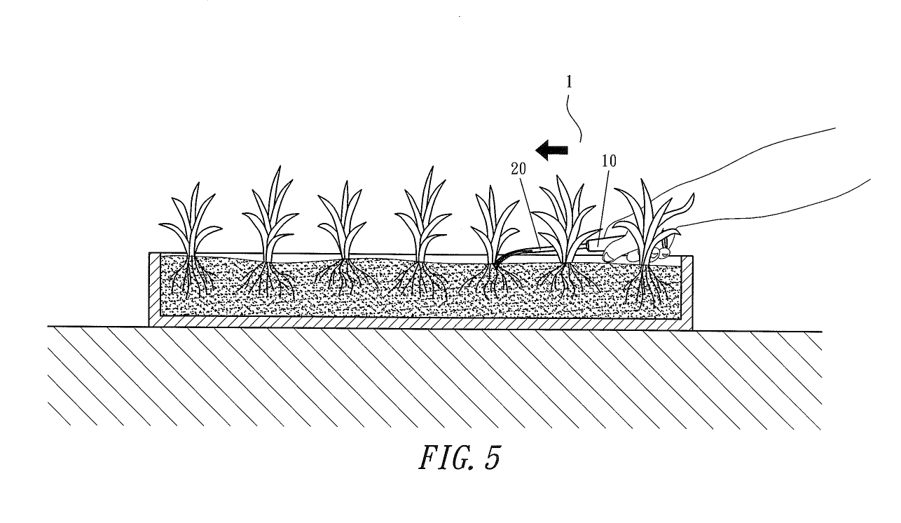

While pulling and loosening the soil, the portion of the sawteeth 222 increases the applied force by the movement of hooking weed roots in order to uproot the weeds and achieve both effects of loosening the soil and weeding. With reference to FIG. 5 for the operation of “just weeding”, the user holds the upper part of the weed (not shown in the figure) by a hand and holds the handle 10 by the other hand to set the blade-like portion 223 of the hand tool portion 22 in a horizontal position and then pushes the hand tool forward, so that the blade-like portion 223 pushes and uproots the weeds. If some root portions are broken, then the soil will be loosened further to expose the weed root and achieve the effect of weeding. Of course, in the operation of “just weeding”, the user may hold the upper part of the weed by a hand, and holds and moves the plurality of sawteeth 222 of the hand tool portion 22 towards the weed root, so that the plurality of sawteeth 222 will hook the weed root, and then the user applies force by both hands to uproot the weed, so as to achieve a quick weeding effect. In addition to using the hand tool 1 for loosening soil and weeding, the user may pull the sharp tip 224 of the hook member 20 of the hand tool 1 backward to sweep the fallen leaves and weeds when there are fallen leaves around and weeds around, so as to achieve the effect of collecting and removing the leaves and weeds conveniently. Obviously, the hand tool 1 has the multipurpose effect.

In the first preferred embodiment, a hand tool 1 comprises a handle 10 and a hook member 20, wherein the hand tool 1 is a hand tool with a short handle for planting. To achieve the multipurpose effect, the present invention adopts various structures and using methods for the hand tool portion 22 of the hook member 20. With the same structure, principle and using effect, a long handle may also be used instead to provide the multipurpose effect of the present invention.

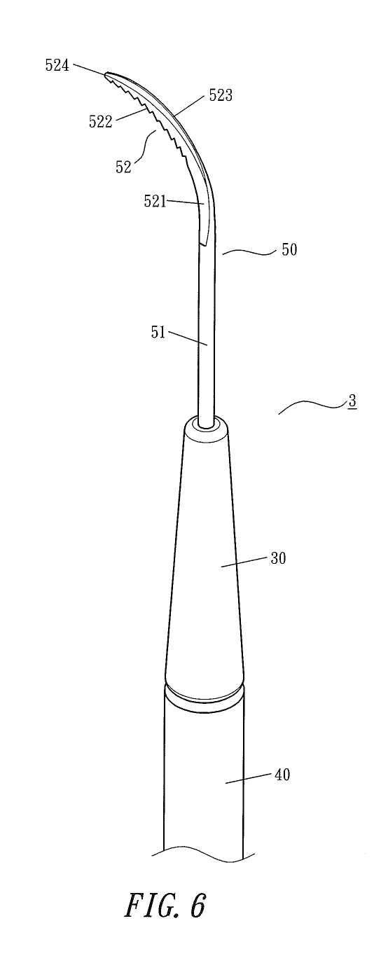

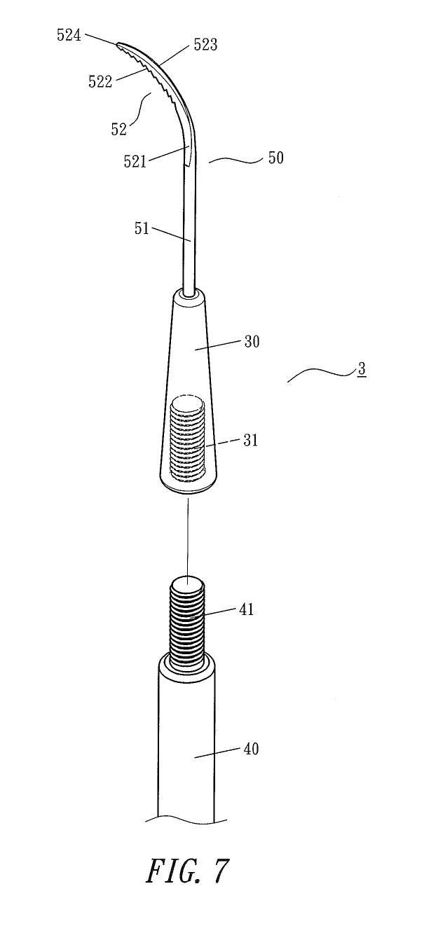

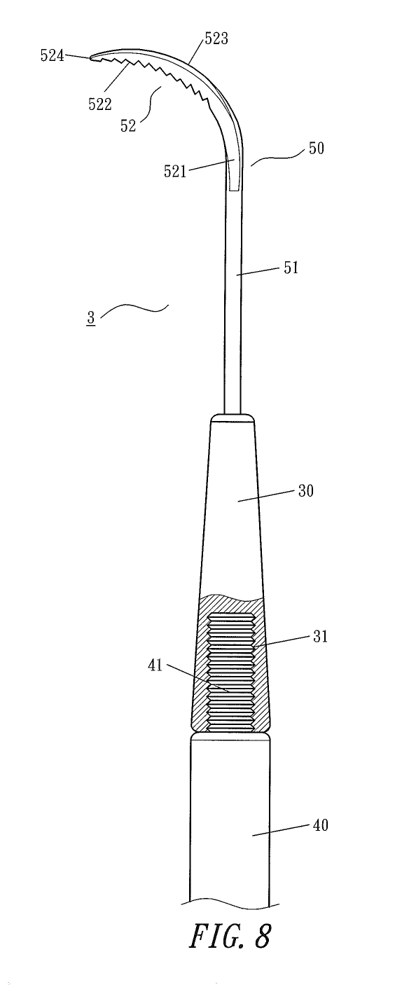

With reference to FIGS. 6 to 8 for a hand tool 3 in accordance with the second preferred embodiment of the present invention, the hand tool 3 is also a hand tool particularly suitable for planting, and the hand tool 3 comprises a handle 30, a long handle 40 and a hook member 50, wherein the outer edge of the handle 30 is in a conical shape with a width increasing in a downward direction (but the invention is not limited to such arrangement only) to facilitate the user to hold the hand tool by hand, and the bottom of the handle 30 has an inner thread slot 31 inwardly formed thereon (as shown in FIG. 7); the long handle 40 is a rod body with an appropriate length, and the rod body may be a flexible rod body (but the invention is not limited to such arrangement only), and the top of the long handle 40 is extended upward to form an outer screw 41 (as shown in FIG. 7), and the outer screw 41 is configured to be corresponsive to the inner thread slot 31 of the handle 30 for a secured screw connection as shown in FIG. 8; the hook member 50 has the same structure as the hook member 20 of the first preferred embodiment and the hook member 50 is fixed into the interior of the handle 30 by a root portion of a rod body 51, and then extended forward from the front end of the handle 30 to a distance and bent into an arc to form a hook-shaped hand tool portion 52; a flat deformation 521 occurs at a position where the hook member 50 starts being bent into the hand tool portion 52, and an inner edge is formed into a plurality of sawteeth 522, and both ends of an outer arc are extended upwardly and focused into a small arc to form a blade-like portion 523, and the front is slightly tapered to form a sharp tip 524.

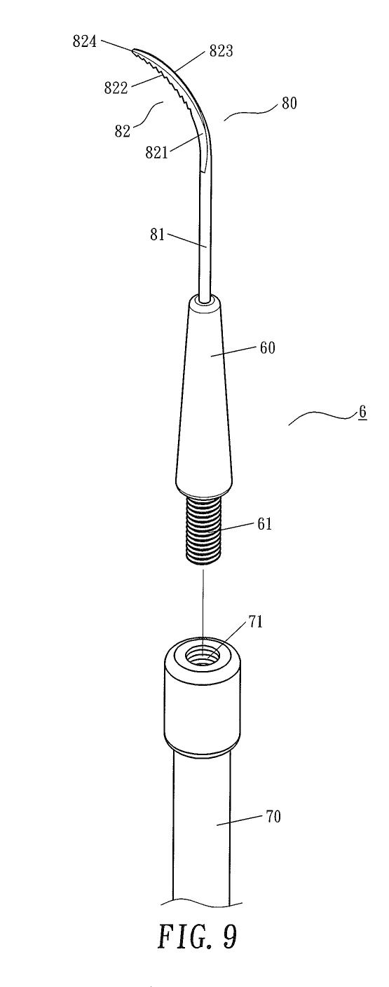

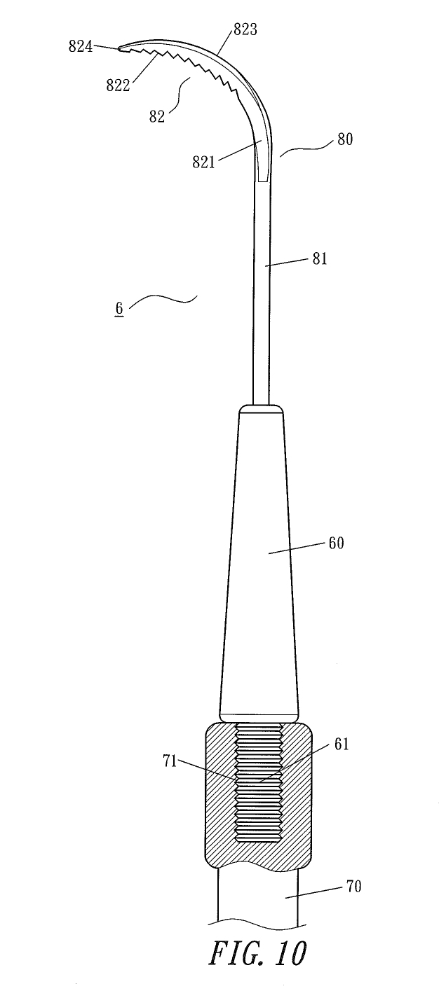

With reference to FIGS. 9 and 10 for a hand tool 6 in accordance with the third preferred embodiment of the present invention, the hand tool 6 is also a hand tool particularly suitable for planting, and the hand tool 6 comprises a handle 60, a long handle 70 and a hook member 80, wherein an outer edge of the handle 60 is in a conical shape with a width increasing in a downward direction (but the invention is not limited to such arrangement only) to facilitate the user to hold the hand tool by hand, and the bottom of the handle 60 has an outer thread slot 61 downwardly formed thereon (as shown in FIG. 9); the long handle 70 has a rod body with an appropriate length, and the rod body may be a flexible rod body (but the invention is not limited to such arrangement only), and the top of the long handle 70 has an inner thread slot 71 formed thereon (as shown in FIG. 9), and the inner thread slot 71 is configured to be corresponsive to the outer screw 61 of the handle 60 for a secured screw connection as shown in FIG. 10; the hook member 80 has the same structure as the hook member 20, 50 of the first and second preferred embodiments and the hook member 80 is fixed into the interior of the handle 60 by a root portion of a rod body 81, and then extended forward from the front end of the handle 60 to a distance and bent into an arc to form a hook-shaped hand tool portion 82; a flat deformation 821 occurs at a position where the hook member 80 starts being bent into the hand tool portion 82, and an inner edge is formed into a plurality of sawteeth 822, and both ends of an outer arc are extended upwardly and focused into a small arc to form a blade-like portion 823, and the front is slightly tapered to form a sharp tip 824.

The use of the hand tool 3 of the second preferred embodiment and the hand tool 6 of the third preferred embodiment of the present invention may be in a short handle mode or a long handle mode. If the hand tool 3, 6 adopts a short handle mode, the hand tool 3 will release the original screw connection between the outer screw 41 of the long handle 40 and the inner thread slot 31 of the handle 30, so that the long handle 40 and the handle 30 are separated completely and also will release the original screw connection between the inner thread slot 71 of the long handle 70 and the outer screw 61 of the handle 60, so that the long handle 70 and the handle 60 are separately completely. As shown in FIGS. 4 and 5, the user holds the handle 30, 60 by a hand to operate the hand tool portions 52, 82 of the hook member 50, 80 to perform the collecting the fallen leaves and removing the weeds after the operations of loosening soil, weeding, sweeping fallen leaves and removing weeds.

If the hand tool 3, 6 adopts the long handle mode, then the hand tool 3 will resume the original screw connection between the outer screw 41 of the long handle 40 and the inner thread slot 31 of the handle 30, and the user may hold the long handle 40 to link the handle 30 and the hook member 50 for the operation. The hand tool 6 will resume the original screw connection between the inner thread slot 71 of the long handle 70 and the outer screw 61 of the handle 60, and the user may hold the long handle 70 to link the handle 60 and the hook member 80 for the operation.

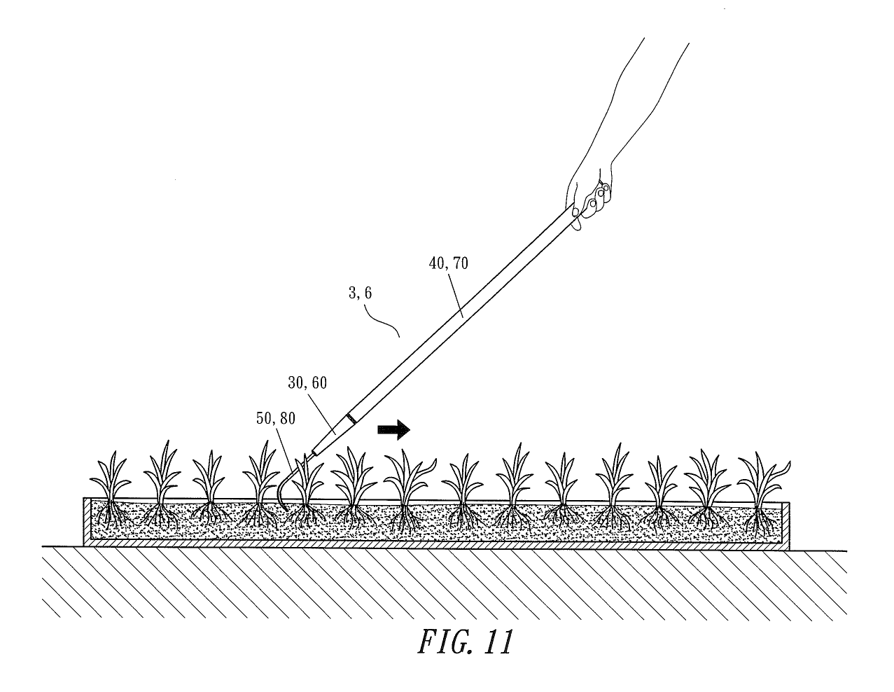

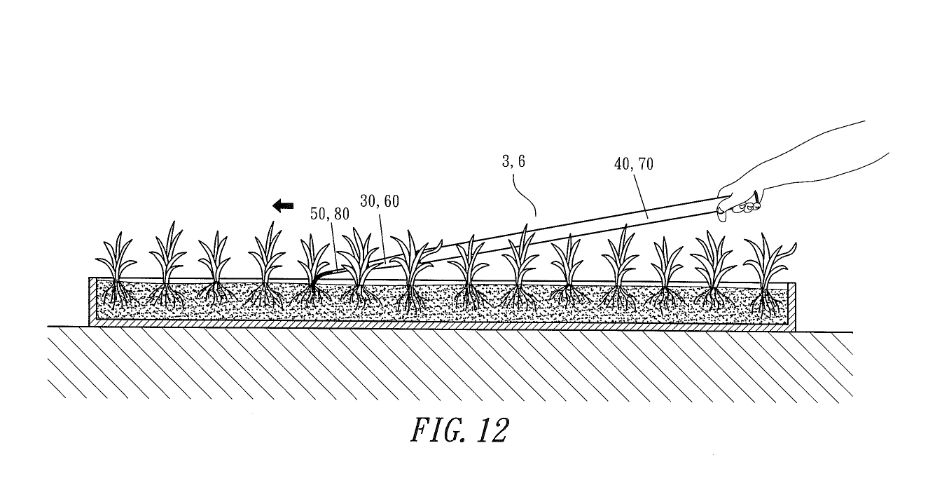

If the hand tool 3, 6 adopts the long handle mode, the user just simply holds an appropriate position of the long handle 40, 70 by a palm to link the handle 30, 60 to extend forward, so that the hook member 50, 80 is extended further towards the user's body, and the hand tool portion 52, 82 of the hook member 50, 80 can be used for the collecting and removing operations after the operations of weeding, sweeping fallen leaves and removing weeds in order to loosen the soil at a farther position or a lush position. In FIG. 11, the user holds the long handle 40, 70 by a palm to operate the hand tool portion 52, 82 of the hook member 50, 80 to insert the hand tool into the soil deeply, and then pulls the hand tool backward and uses the sharp tip 524, 824 of the hand tool portion 52, 82 to scrap the soil, while using the sawteeth 522, 822 to hook the weed root, so as to achieve both effects of loosening soil and weeding easily at the same time. In FIG. 12, the user may set and push the blade-like portion 523, 823 of the hand tool portion 52, 82 in a horizontal position and use the blade-like portion 523, 823 to push and move the weeds for the weeding effect or the user may hold the upper part of the weed by a hand and operate the plurality of sawteeth 522, 822 of the hand tool portion 52, 82 to hook the weed root by the other hand, and then uses both hands to apply a force to uproot the weeds, so as to achieve the weeding effect. The hand tool 3, 6 used for the operations of collecting fallen leaves and removing weeds after the operations of loosening soil, weeding, sweeping fallen leaves and removing weeds is substantially the same as the hand tool 1 of the first preferred embodiment, except the hand tool 3, 6 can be extended further to facilitate a far-distance operation. In addition, the user may not squat at a low position to use the hand tool 3, 6 and work at a low position, and the hand tools 3, 6 of the present invention also have the advantage of removing dried leaves from a tree conveniently.

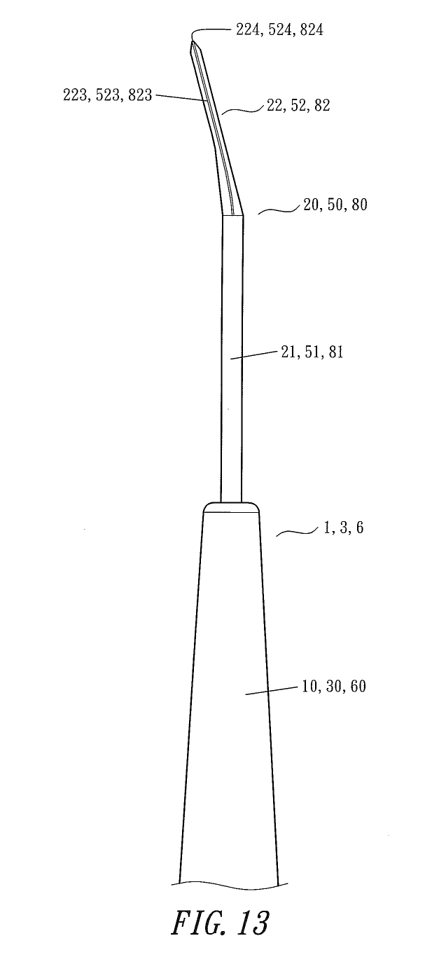

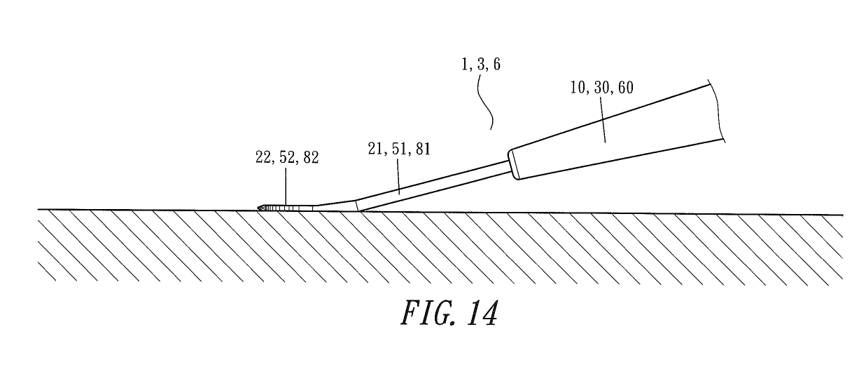

Above, regardless of the hand tool 1 or the hand tool 3, 6, the hook member 20, 50, 50 are formed by the rod body 21, 51, 81 extending forward from the front end of the handle 10, 30, 60 to a distance and bending into an arc to form the hook-shaped hand tool portion 22, 52, 82. As shown in FIG. 13, The rod body 21, 51, 81 of the hook member 20, 50, 80 extend forward from the front end of the handle 10, 30, 60 and simultaneously deflect to one side (as the left side of FIG. 13) with an angle (about 20 degrees is appropriate, but not limited) in the location where the rod body bend into an arc to than the hook-shaped hand tool portion 22, 52, 82. Therefore, the using as shown in FIG. 14, the user operates the handle 10, 30, 60 obliquely to facilitate the hand tool portion 22, 52, 82 being more closed to the ground, and the practicality is promoted thereof.

In view of the description above, the present invention has the following major advantageous feature. In the hand tool, a hook member is extended forward from the front of the handle, and the hook member is fixed into the interior of the handle by a root portion of a rod body, and then to a distance and then bent into an arc to form a hook-shaped hand tool portion, and the hook member has a flat deformation at the position where the bending starts to form the hand tool portion, and a plurality of sawteeth formed at an inner edge, and both sides of the outer arc are bent upwardly and focused into a small arc to form a blade-like portion, and the front being tapered into a sharp tip. The hand tool of the present invention includes the plurality of sawteeth of the hand tool portion, the blade-like portion and the sharp tip to provide a multipurpose planting hand tool particularly suitable for the operation of collecting fallen leaves and removing weeds after the operations of loosening soil, weeding, sweeping fallen leaves and removing weeds.

In summation of the above description, the present invention herein enhances the performance than the conventional structure and further complies with the patent application requirements and is submitted for patent application. While the invention has been described by means of specific embodiments, numerous modifications and variations could be made thereto by those skilled in the art without departing from the scope and spirit of the invention set forth in the claims.

1. A multipurpose planting hand tool comprising:
a handle provided for a user to hold; and
a hook member, having a rod body, fixed into an interior of the handle by a root portion of the rod body, with the rod body being extended from a front of the handle to a distance and then bent at a bending to form a hook-shaped hand tool portion, with the hook member having a flat deformation beginning at the bending to form the hook-shaped hand tool portion, with the hook-shaped hand tool portion including inner and outer surfaces at an angle greater than 90 degrees to the rod body, an inner edge of the angle and an outer edge of the angle, with a plurality of sawteeth formed at the inner edge, with the inner and outer edge being tapered into a sharp tip.

2. The multipurpose planting hand tool of claim 1, further comprising a long handle, with a top end of the long handle being coupled to a bottom of the handle.

3. The multipurpose planting hand tool of claim 2, wherein the bottom of the handle has an inner threaded slot inwardly formed thereon, wherein the top end of the long handle has an outer screw formed thereon and extended upwardly, and wherein the outer screw is configured to be corresponsive to the inner threaded slot for a secured screw connection.

4. The multipurpose planting hand tool of claim 2, wherein the bottom of the handle has an outer screw downwardly formed thereon, wherein the top end of the long handle has an inner threaded slot formed inwardly thereon, and wherein the inner threaded slot is configured to be corresponsive to the outer screw for a secured screw connection.

5. The multipurpose planting hand tool of claim 1, wherein an outer edge of the handle is in a conical shape with an increasing width.

6. The multipurpose planting hand tool of claim 2, wherein a rod body of the long handle is a flexible rod body.

7. The multipurpose planting hand tool of claim 1, wherein the hand tool portion of the rod body is capable of deflecting to one side with an angle to facilitate the hook-shaped hand tool portion being closer to the ground.

8. The multipurpose planting hand tool of claim 1, wherein the inner and outer surfaces of the hook-shaped hand tool portion have an arc shape from the rod body to the sharp tip.

9. The multipurpose planting hand tool of claim 1, wherein the inner and outer surfaces of the hook-shaped hand tool portion are flat from the rod body to the sharp tip.
